(19) United States
(12) Patent Application Publication
(10) Pub. No.: US 2017/0015774 A1
(43) Pub. Date: Jan. 19, 2017

(54) ACTIVE ENERGY RAY-CURABLE RESIN COMPOSITION AND AUTOMOBILE HEADLAMP LENS

(71) Applicant: MITSUBISHI RAYON CO., LTD., Chiyoda-ku (JP)

(72) Inventors: Akira MIYACHI, Toyohashi-shi (JP); Hiroyuki SATOU, Chiyoda-ku (JP)

(73) Assignee: MITSUBISHI RAYON CO., LTD., Chiyoda-ku, Tokyo (JP)

(21) Appl. No.: 15/124,721

(22) PCT Filed: Mar. 9, 2015
(86) PCT No.: PCT/JP2015/056837

§ 371 Date: Sep. 9, 2016

(30) Foreign Application Priority Data
Mar. 11, 2014 (JP) 2014-047417

(51) Int. Cl. C08F 290/06; C08G 18/75; C08G 18/83; C08G 18/44; F21S 8/10; C09D 151/08; B05D 1/02; B05D 1/18; B05D 1/30; B05D 1/28; C08G 18/48; C08G 18/42

(52) U.S. Cl. CPC C08F 290/067; C08G 18/4854; C08G 18/758; C08G 18/831; C08G 18/44; C08G 18/4277; C09D 151/08; B05D 1/02; B05D 1/18; B05D 1/305; B05D 1/28; F21S 48/1225

(57) ABSTRACT

Provided is an active energy ray-curable resin composition with which it is possible to form a cured film, having outstanding scratch resistance, hardness, and weather resistance, on the surface of a molded resin article for an automobile headlamp lens. The active energy ray-curable resin composition is used to form a cured film on the surface of a molded resin article for an automobile headlamp lens and comprises (A) 10-70% by mass of a mono- or poly-pentaerythritol poly(meth)acrylate compound having a specific structure, (B) 10-50% by mass of a urethane(meth)acrylate compound having at least two (meth)acryloyloxy groups, at least one amido group, and at least two urethane bonds, and (C) 20-80% by mass of a poly[(meth)acryloyloxyalkyl]isocyanurate compound having a specific structure.

### FIELD OF THE INVENTION

The present invention relates to an active energy ray-curable resin composition and an automobile headlamp lens having a cured film of the composition.

### BACKGROUND ART

Synthetic resin molded products containing resins such as polymethyl methacrylate, polymethacryl imide, polycarbonate, polystyrene and acrylonitrile-styrene (AS) are lightweight and exhibit excellent antishock and high transparency properties. Thus, they are used in plastic automotive parts, for example, various lamp lenses, glazing materials, gauge-panel covers, and the like. Especially, with lightweight automobiles for improved fuel efficiency and with diversified designs in mind, the aforementioned synthetic resin molded products are increasingly used for headlamp lenses. However, since such synthetic resin molded products have low surface wear resistance, their surfaces tend to be damaged by contact with hard items, friction, scratching and the like. Such surface damage not only depreciates the value of the product but also reduces safety. Accordingly, providing wear resistance is significantly important. In addition, when the aforementioned synthetic resin molded products are used for plastic automotive parts, providing weather resistance is also important. Especially, since the polymer chain of polycarbonate resins tends to deteriorate when exposed to ultraviolet rays and causes yellowed, cracked surfaces or the like, polycarbonate resin molded products show low weatherability.

A method proposed to solve the above problems of synthetic resin molded products is to form a cross-linked film by irradiating active energy rays at the products after coating a resin composition that contains a radical polymerizable monomer (Patent Literature 1). Since active energy ray-curable resin compositions are cured immediately after being irradiated by active energy rays such as ultraviolet rays and form a hard film on surfaces of synthetic resin molded products, those compositions provide excellent hardness and wear resistance properties. Also, the entire processing cost is low when those compositions are used, because processing speed is facilitated, and high productivity is achieved.

In addition, using an ultraviolet absorber is effective in protecting the polycarbonate as the base material from ultraviolet ray-caused deterioration. However, when ultraviolet rays are used as active energy rays for curing the composition, an ultraviolet absorber with a high concentration significantly inhibits the curing in deep portions of the coating. Accordingly, the cured film is not hard enough, and adhesion with the base material is low.

### PRIOR ART LITERATURE

### Patent Literature

Patent Literature 1: JP H06-128502A

### SUMMARY OF THE INVENTION

### Problems to be Solved by the Invention

The technology disclosed in Patent Literature 1 is capable of providing enough hardness and excellent weather resistance properties when cured film is formed on a polycarbonate resin molded product to be used for automobile headlamp lenses under outdoors conditions and the like. However, if the crosslinking density of cured film is set higher to further enhance the hardness of automobile headlamp lenses as required recently, the internal contraction force of the coating increases when active energy rays are irradiated. Thus, under conditions such as repeated heating/cooling and long exposure to the natural outdoors environment, cracking or peeling may occur in the cured film.

The objective of the present invention is to provide an active energy ray-curable resin composition capable of forming a cured film having excellent scratch resistance, hardness, and weather resistance on the surface of a resin molded product to be used for automobile headlamp lenses. Also, the objective is to provide an automobile headlamp lens having such a cured film.

### Solutions to the Problems

The aspects of the present invention are shown in [1]-[10] below.
[1] An active energy ray-curable resin composition for forming a cured film on the surface of a resin molded product to be used for an automobile headlamp lens, which contains poly(meth)acrylate (A) of mono- or poly-pentaerythritol represented by formula (1) below;

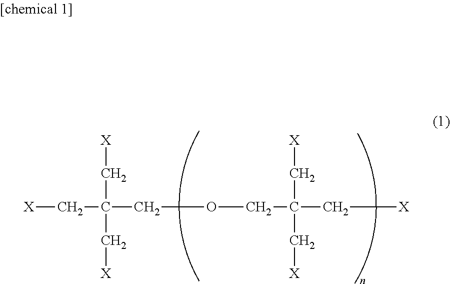

(In the formula, “X's” are each independently a (meth)acryloyloxy group (CH₂═CR—COO—), a (meth)acryloyl group modified with caprolactone (CH₂═CR—CO(O(CH₂)₅C═O)_{y}—) (“R” is hydrogen or a methyl group, and “y” is an integer of 1 or greater), or a (—OH) group. At least three of the “X's” are a (meth)acryloyloxy group (CH₂═CR—COO—) or a (meth)acryloyl group modified with caprolactone (CH₂═CR—CO(O(CH₂)₅C═O)_{y}—) (“R” is hydrogen or a methyl group, and “y” is an integer of 1 or greater), and “n” is an integer of 0-4.)

The active energy ray-curable resin composition also contains a urethane (meth)acrylate mixture (B) containing a urethane (meth)acrylate having at least two (meth)acryloyloxy groups, at least one amide group (which does not include the —NH—CO— structure in the urethane bond), and at least two urethane bonds; and

poly[(meth)acryloyloxy alkyl]isocyanurate (C) represented by formula (2) below.

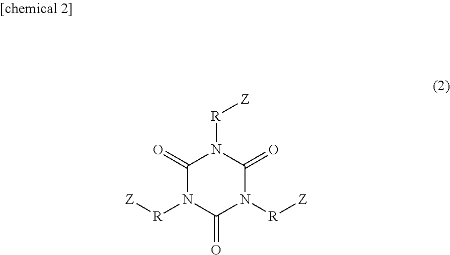

(In the formula, “Z's” are each independently a (meth)acryloyl group, hydrogen atom, or alkyl group. Among them, at least two “Z's” are (meth)acryloyl groups. “R's” are each independently a C1-C4 oxyalkylene group.)

In the active energy ray-curable resin composition, (A) is set at 10-70 mass %, (B) at 10-50 mass % and (C) at 20-80 mass % relative to the total 100 mass % of (A), (B) and (C).
[2] The active energy ray-curable resin composition according to [1], in which the urethane (meth)acrylate mixture (B) is obtained by reacting materials (b1)-(b4) below:
   (b1): diisocyanate;
   (b2): a compound containing at least one amide group (which does not include the —NH—CO— structure in the urethane bond) and at least two hydroxyl groups;
   (b3): at least one type of diol selected from among polyether diols, polycarbonate diols, and polyester diols other than material (b2); and
   (b4): a (meth)acrylic acid ester having at least one (meth)acryloyloxy group, and one hydroxyl group.
[3] The active energy ray-curable resin composition according to [2], in which material (b3) is a polyether diol other than material (b2).
[4] The active energy ray-curable resin composition according to [2] or [3], in which the molar equivalent ratio of materials (b1)-(b4) is [material (b1)]/[material (b2)+material (b3)]/[material (b4)]=10/4-6/4-6.
[5] The active energy ray-curable resin composition according to [2] or [3], in which the molar equivalent ratio of materials (b2) and (b3) is material (b2)/material (b3)=1-5/5-1.
[6] The active energy ray-curable resin composition according to [2] or [3], in which the molar equivalent ratio of materials (b1)-(b4) is [material (b1)]/[material (b2)+material (b3)]/[material (b4)]=10/4-6/4-6, and the molar equivalent ratio of materials (b2) and (b3) is material (b2)/material (b3)=1-5/5-1.
[7] The active energy ray-curable resin composition according to any of [1]-[6], further containing at least either an ultraviolet absorber (D) or a hindered-amine light stabilizer (E).
[8] The active energy ray-curable resin composition according to any of [1]-[7], in which the resin molded product for forming automobile headlamp lenses is a polycarbonate resin molded product.
[9] An automobile headlamp lens containing a cured film of the active energy ray-curable resin composition according to any of [1]-[7], in which the cured film is formed on a resin molded product.
[10] The automobile headlamp lens according to [9], in which the resin molded product is a polycarbonate resin molded product.

### Effects of the Invention

According to the present invention, provided are an active energy ray-curable resin composition capable of forming a cured film having excellent hardness, scratch resistance and weather resistance on the surface of a resin molded product to be used for automobile headlamp lenses. Also provided is an automobile headlamp lens having such a cured film.

### MODE TO CARRY OUT THE INVENTION

As described above, a cured film intended for outdoors use is required to have hardness and scratch resistance while exhibiting weather resistance (anti-cracking) that is in conflict with those properties. To enhance the hardness of a cured film, forming hydrogen bonds between molecules may be an option in addition to increasing crosslinking density. Examples of functional groups that form hydrogen bonds are amide groups. However, amide groups in polyamides such as nylon tend to undergo hydrolysis when exposed to outdoor conditions for a long time, resulting in deterioration and coloring of the film. Thus, raw materials containing amide groups are not thought to be preferable for applications that require long-term weather resistance such as the field of the present invention.

The inventors of the present invention have conducted intensive studies to solve the above problems, and found that when urethane acrylate having a specific amide group is used at a specific rate, the hardness and scratch resistance of a cured film are enhanced without a decrease in weather resistance. Namely, the inventors of the present invention have achieved an active energy ray-curable resin composition, which contains components (A)-(C) at a specific ratio and which is capable of forming a cured film that exhibits excellent hardness and scratch resistance as well as excellent weather resistance.

In the following, embodiments of the present invention are described in detail. Here, a group denoted as CH₂═C(R)C(O)O— (“R” is a hydrogen atom or a methyl group) is an acryloyloxy group (where “R” is a hydrogen atom) or a methacryloyloxy group (where “R” is a methyl group), and may also be referred to as a (meth)acryloyloxy group. In the same manner, “acrylate” and “methacrylate” are collectively referred to as “(meth)acrylate.”

### <Component (A)>

Component (A) to be used in the present embodiment is poly(meth)acrylate of mono- or poly-pentaerythritol represented by formula (1) above. When irradiated by active energy rays, component (A) exhibits excellent polymerization activity, thereby forming a polymer with a high crosslinking density to have excellent scratch-resistance properties. Accordingly, component (A) is capable of forming a cured film with excellent scratch resistance.

Specific examples of component (A) are tri-functional (meth)acrylates such as pentaerythritol tri(meth)acrylate, pentaerythritol tri(meth)acrylate modified with caprolactone, and dipentaerythritol tri(meth)acrylate; tetra-functional (meth)acrylates such as pentaerythritol tetra(meth)acrylate, pentaerythritol tetra(meth)acrylate modified with caprolactone, dipentaerythritol tetra(meth)acrylate, and tripentaerythritol tetra(meth)acrylate; penta-functional (meth)acrylates such as dipentaerythritol penta(meth)acrylate, dipentaerythritol penta(meth)acrylate modified with caprolactone, and tripentaerythritol penta(meth)acrylate; hexa-functional (meth)acrylates such as dipentaerythritol hexa(meth)acrylate, dipentaerythritol hexa(meth)acrylate modified with caprolactone, and tripentaerythritol hexa(meth)acrylate; hepta- or higher functional (meth)acrylates such as tripentaerythritol hepta(meth)acrylate, and tripentaerythritol octa(meth)acrylate. They may be used alone or in combination thereof.

As for component (A), a (meth)acrylate compound where “n” is 0-2, more preferably “n” is 1, in formula (1) above. Among them, tetra- to hexa-functional (meth)acrylate compounds are further preferred. Especially preferred examples are dipentaerythritol tetra(meth)acrylate, dipentaerythritol penta(meth)acrylate, dipentaerythritol penta(meth)acrylate modified with caprolactone, dipentaerythritol hexa(meth)acrylate, and dipentaerythritol hexa(meth)acrylate modified with caprolactone.

The amount of component (A) in the active energy ray-curable resin composition is 10-70 mass %, preferably 20-50 mass %, more preferably 30-40 mass %, relative to the total 100 mass % of components (A)-(C). If the amount of component (A) is less than 10 mass %, the cured film does not exhibit sufficient scratch resistance. If the amount of component (A) exceeds 70 mass %, cracking tends to occur in the cured film. For example, cracking is more likely to occur in the cured film after durability and weather resistance are tested. In addition, the heat resistance of the cured film is lowered.

### <Component (B)>

Component (B) of the present embodiment is a urethane (meth)acrylate mixture containing urethane (meth)acrylate having at least two (meth)acryloyloxy groups, at least one amide group (which does not include the —NH—CO— structure in the urethane bond), and at least two urethane bonds. In the present application, a urethane (meth)acrylate mixture consisting of only one type of urethane (meth)acrylate, which has at least two (meth)acryloyloxy groups, at least one amide group (which does not include the —NH—CO— structure in the urethane bond), and at least two urethane bonds, is also referred to as a “mixture” for the sake of description. Component (B) is capable of enhancing the rigidity, flexibility, heat resistance and weather resistance of the cured film. The (meth)acryloyloxy group is radical polymerizable. Component (B) is preferred to be a mixture obtained by reacting materials (b1)-(b4), considering balanced hardness and weather resistance of the cured film.

The method for synthesizing component (B) is not particularly limited. For example, when material (b1) and a polyurethanizing catalyst are mixed, into which materials (b2) and (b3) are dropped at 50-90° C., isocyanate-terminated polyurethane is obtained as its precursor. Then, material (b4) is further dropped into the mixture and heated to carry out addition reactions. Accordingly, a urethane (meth)acrylate mixture is obtained as component (B).

When component (B) is a mixture obtained by reacting materials (b1)-(b4), the molar equivalent ratio of materials (b1)-(b4) of component (B) is preferred to be [material (b1)]/[material (b2)+material (b3)]/[material (b4)]=10/4-6/4-6, more preferably 10/4-5/5-6, from the viewpoint of providing weather resistance properties. In addition, considering the balance in the hardness and weather resistance of the cured film, the molar equivalent ratio of materials (b2) and (b3) is preferred to be material (b2)/material (b3)=1-5/5-1, more preferably 1-4/4-1. Here, molar equivalent is obtained by multiplying the number of moles and the number of functional groups of the compound.

In component (B), the rate of urethane (meth)acrylate that contains at least two (meth)acryloyloxy groups, at least one amide group, and at least two urethane bonds is preferred to be at least 10 mass %, more preferably at least 15 mass %, even more preferably at least 25 mass %, considering the hardness of the cured film. In addition, considering the effect derived from another urethane (meth)acrylate, the rate is preferred to be no greater than 80 mass %, more preferably no greater than 60 mass %, even more preferably no greater than 40 mass %.

The urethane (meth)acrylate mixture obtained by reacting materials (b1)-(b4) mainly contains urethane (meth)acrylate (X) having the structure of [residue: material (b4) minus a hydroxyl group] —O—CO—NH— [residue: material (b1) minus 2 NCO groups] —NH—CO—O— [residue: material (b2) minus 2 hydroxyl groups] —O—CO—NH— [residue: material (b1) minus 2 NCO groups] —NH—CO—O [residue: material (b4) minus a hydroxyl group], and urethane (meth)acrylate (Y) having the structure of [residue: material (b4) minus a hydroxyl group] —O—CO—NH— [residue: material (b1) minus 2 NCO groups] —NH—CO—O— [residue: material (b3) minus 2 hydroxyl groups] —O—CO—NH— [residue: material (b1) minus 2 NCO groups] —NH—CO—O [residue: material (b4) minus a hydroxyl group].

Urethane (meth)acrylate (X) corresponds to a urethane (meth)acrylate having at least two (meth)acryloyloxy groups, at least one amide group and at least two urethane bonds, whereas urethane (meth)acrylate (Y) does not have such a structure. In the present application, the amount of a urethane (meth)acrylate having at least two (meth)acryloyloxy groups, at least one amide group and at least two urethane bonds is defined to be the mass ratio of urethane acrylate (X) to the total amount of urethane acrylates (X) and (Y) in the mixture.

The amount of component (B) in an active energy ray-curable resin composition is 10-50 mass %, preferably 15-40 mass %, more preferably 20-30 mass %, of the total 100 mass % of components (A)-(C). If the amount of component (B) is less than 10 mass %, the cured film does not exhibit sufficient weather resistance. If the amount of component (B) exceeds 50 mass %, scratch resistance is lowered.

<Material (b1)>

Material (b1) is diisocyanate, and contributes to providing flexibility to the cured film.

Specific examples of material (b1) are aliphatic diisocyanates such as hexamethylene diisocyanate, 2,4,4-trimethylhexamethylene diisocyanate, 2,2,4-trimethylhexamethylene diisocyanate, isophorone diisocyanate, bis(4-isocyanatocyclohexyl) methane, 1,2-hydrogenated xylylene diisocyanate, 1,4-hydrogenated xylylene diisocyanate, hydrogenated tetramethyl xylylene diisocyanate, and norbornane diisocyanate; and aromatic diisocyanates such as bis(4-isocyanatophenyl) methane, bis(3-chloro-4-isocyanatophenyl) methane, 2,4-tolylene diisocyanate, 2,6-tolylene diisocyanate, 1,2-xylylene diisocyanate, 1,4-xylylene diisocyanate, tetramethyl xylylene diisocyanate, and naphthalene diisocyanate. They may be used alone or in combination thereof.

From the viewpoint of providing the cured film with excellent pencil hardness and weather resistance (anti-yellowing), material (b1) is preferred to be an aliphatic diisocyanate among those listed above, more preferably the following: isophorone diisocyanate, bis(4-isocyanatocyclohexyl)methane, 1,2-hydrogenated xylylene diisocyanate, 1,4-hydrogenated xylylene diisocyanate, hydrogenated tetramethyl xylylene diisocyanate, norbornane diisocyanate, 2,4,4-trimethylhexamethylene diisocyanate, and 2,2,4-trimethyl hexamethylene diisocyanate.

<Material (b2)>

Material (b2) is a compound containing at least one amide group and at least two hydroxyl groups. Hydroxyl groups react with isocyanate. Material (b2) is the component that contributes to enhancing hardness while maintaining the flexibility of the cured film.

An example of material (b2) is a product obtained by reacting a cyclic hydroxycarboxylic acid ester and a compound containing one primary or secondary amino nitrogen and one hydroxyl group.

Specific examples of a cyclic hydroxycarboxylic acid ester are γ-butyrolactone, γ-valerolactone, δ-valerolactone, ε-caprolactone, and the like. They may be used alone or in combination thereof. Among them, γ-butyrolactone and γ-valerolactone are preferred.

Examples of a compound containing a primary or secondary amino nitrogen are ethanolamine, diethanolamine, N-methyl ethanolamine, N-ethyl ethanol amine, N-phenylethanolamine, 2-amino-1-butanol, 2-amino-2-ethyl-1,3-propanediol, 6-amino-1-hexanol, and the like. They may be used alone or in combination thereof. Among them, a compound containing a primary or secondary amino nitrogen is preferred to be ethanolamine, diethanolamine, or N-methylethanolamine.

Material (b2) is preferred to be 4-hydroxy-N-(2-hydroxyethyl)-N-methylbutanamide obtained by reacting γ-butyrolactone and N-methylethanolamine.

Reaction of a cyclic hydroxycarboxylic acid ester and a compound containing a primary or secondary amino nitrogen and a hydroxyl group is carried out by making an equimolar mixture, which is then heated at approximately 100° C. for 6-24 hours.

<Material (b3)>

Material (b3) is at least a diol compound selected from among polyether diols, polycarbonate diols and polyester diols other than material (b2). Material (b3) is a component that contributes to enhancing the flexibility and elasticity of the cured film. Considering weather resistance properties, material (b3) is preferred to be a polyether diol other than material (b2).

Specific examples of material (b3) are polyethylene glycol (n=6-20), polypropylene glycol (n=6-20), polybutylene glycol (n=6-20), 1-methyl-butylene glycol (n=6-20), polycaprolactone diol, alkylene diol (C2-C10) with caprolactone diol (n=2-10) adduct, polycarbonate diol (C2-C6 aliphatic skeleton), polyester diol derived from phthalic acid and alkylene diol, polyester diol derived from maleic acid and alkylene diol, polyester diol derived from fumaric acid and alkylene diol, and the like. They may be used alone or in combination thereof.

Among those listed above, material (b3) is preferred to be polybutylene glycol (n=6-20), polycaprolactone diol or polycarbonate diol (C2-C6 aliphatic skeleton). The number-average molecular weight of material (b3) is preferred to be 300-2000, more preferably 500-1500. The number-average molecular weight is converted from the hydroxyl value.

<Material (b4)>

Material (b4) is a hydroxyl group-containing (meth)acrylic acid ester having at least one (meth)acryloyloxy group and a hydroxyl group. The hydroxyl group has reactivity with isocyanate. Material (b4) is a component that provides radical reactivity by being added to a terminal of synthesized polyurethane precursor.

Specific examples of material (b4) are 2-hydroxyethyl(meth)acrylate, 2-hydroxypropyl(meth)acrylate, 4-hydroxybutyl(meth)acrylate, 6-hydroxyhexyl(meth)acrylate, cyclohexanedimethanol mono(meth)acrylate, caprolactone adduct of 2-hydroxyethyl(meth)acrylate, caprolactone adduct of 4-hydroxybutyl(meth)acrylate, trimethylolpropane diacrylate, pentaerythritol triacrylate, dipentaerythritol pentaacrylate, and the like. They may be used alone or in combination thereof.

Among those listed above, material (b4) is preferred to be 2-hydroxyethyl(meth)acrylate, 2-hydroxypropyl(meth)acrylate or 4-hydroxybutyl(meth)acrylate

### <Component (C)>

Component (C) used in the present embodiment is poly[(meth)acryloyloxy alkyl]isocyanurate represented by formula (2) above. Component (C) exhibits excellent polymerization activity when irradiated by active energy rays, and is capable of improving the adhesiveness of cured film without lowering excellent wear resistance after hot water resistance testing.

Specific examples of component (C) are bis(2-acryloyloxyethyl)hydroxyethyl isocyanurate, tris(2-acryloyloxyethyl)isocyanurate, bis(2-acryloyloxypropyl)hydroxyethyl isocyanurate, tris(2-acryloyloxypropyl)isocyanurate, and the like. They may be used alone or in combination thereof. Among them, component (C) is preferred to be bis(2-acryloyloxyethyl)hydroxyethyl isocyanurate or tris(2-acryloyloxyethyl)isocyanurate, from the viewpoint of achieving high polymerization activity and excellent wear resistance.

The amount of component (C) in the active energy ray-curable resin composition is 20-80 mass %, preferably 30-60 mass %, more preferably 35-50 mass %, relative to the total 100 mass % of components (A)-(C). If the amount of component (C) is less than 20 mass %, the cured film does not exhibit sufficient adhesiveness. If the amount of component (C) exceeds 80 mass %, scratch resistance is lowered.

### <Component (D)>

The composition related to the present invention is preferred to contain component (D) when weather resistance is considered. The ultraviolet absorber as component (D) is not limited to any particular type. However, from the viewpoints of high solubility in the composition related to the present invention and excellent weather-resistance properties, component (D) is preferred to be selected from among benzophenones, benzotriazoles, triazines, phenyl salicylates, and phenyl benzoates, in which the maximum absorption wavelength is in a range of 240-380 nm. Component (D) is more preferred to be a benzophenone ultraviolet absorber, since a large amount of such an ultraviolet absorber can be contained in the composition related to the present invention. Component (D) is more preferred to be a benzotriazole or triazine ultraviolet absorber, since it is capable of preventing yellowing of the base material such as polycarbonate.

Specific examples of component (D) are benzophenones such as 2-hydroxybenzophenone, 5-chloro-2-hydroxybenzophenone, 2,4-dihydroxybenzophenone, 2-hydroxy-4-methoxybenzophenone, 2-hydroxy-4-octyloxybenzophenone, 4-dodecyloxy-2-hydroxybenzophenone, 2-hydroxy-4-octadecyloxybenzophenone, 2,2′-dihydroxy-4-methoxybenzophenone, and 2,2′-dihydroxy-4,4′-dimethoxybenzophenone; benzotriazoles such as 2-(2-hydroxy-5′-methylphenyl)benzotriazole, 2-(2-hydroxy-5-tert-butylphenyl)-5-chlorobenzotriazole, 2-(2-hydroxy-3,5-di-tert-butylphenyl)benzotriazole, 2-(2-hydroxy-5-tert-butylphenyl)benzotriazole, and 2-(2-hydroxy-4-octylphenyl)benzotriazole; triazines such as 2-[14-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis (2,4-dimethylphenyl)-1,3,5-triazine, 2-[4-[(2-hydroxy-3-(2′-ethyl)hexyl)oxy]-2-hydroxyphenyl]-4,6-bis (2,4-dimethylphenyl)-1,3,5-triazine, 2,4-bis(2-hydroxy-4-butyroxyphenyl)-6-(2,4-bisbutyroxyphenyl)-1,3,5-triazine, and 2-(2-hydroxy-4-[1-octyl oxycarbonyl ethoxy]phenyl)-4,6-bis(4-phenylphenyl)-1,3,5-triazine; phenyl salicylates such as phenyl salicylate, p-tert-butylphenyl salicylate, and p-(1,1,3,3-tetramethylbutyl)phenyl salicylate; phenyl benzoates such as 3-hydroxy-phenyl benzoate, and phenylene-1,3-dibenzoate. Those listed here may be used alone or in combination thereof.

Among those listed above, component (D) is preferred to be selected from among benzotriazoles and triazines; more preferably, 2-(2-hydroxy-5-tert-butylphenyl)benzotriazole or 2-[4-[(2-hydroxy-3 -dodecyl oxypropyl)oxy]-2-hydroxyphenyl]-4,6-bis(2,4-dimethylphenyl)-1,3,5-triazine, considering weather resistance properties and solubility in the composition related to the present invention.

The amount of component (D) in the active energy ray-curable resin composition is 1-30 parts by mass, preferably 2-20 parts by mass, more preferably 5-15 parts by mass, relative to the total 100 mass % of components (A)-(C). The larger the amount of component (D), the more excellent is the weather resistance obtained in the cured film, and excellent protection (anti-yellowing) from ultraviolet rays is thereby achieved in the base material. The smaller the amount of component (D), the more enhanced is the hardness, adhesiveness and heat resistance of the cured film.

### <Component (E)>

The composition related to the present invention is preferred to contain component (E) from the viewpoint of weather resistance. A hindered amine-based photostabilizer as component (E) is not limited particularly. Specific examples of component (E) are condensates of 1,2,3,4-butanetetracarboxylic acid, 1,2,2,6,6-pentamethyl-4-piperidinol, and β, β, β, β-tetramethyl-3,9-(2,4,8,10-tetraoxaspiro[5,5](undecane)diethanol; condensates of 1,2,3,4-butanetetracarboxylic acid, 2,2,6,6-pentamethyl-4-piperidinol, and β, β, β, β-tetramethyl-3,9-(2,4,8,10-tetraoxaspiro[5,5](undecane)diethanol; condensates of 1,1-dimethylethyl hydroperoxid and octane; 2,4-bis[N-butyl-N-(1-cyclohexyloxy-2,2,6,6-tetramethylpiperidin-4-yl)amino]-6-(2-hydroxyethylamine)-1,3,5-triazine, bis(1,2,2,6,6-pentamethyl-4-piperidyl)sebacate, and the like.

Also, component (E) may be a hindered amine-based photostabilizer having a (meth)acryloyl group in the molecule, for example, a reaction product of 2,4-bis[N-butyl-N-(1-cyclohexyloxy-2,2,6,6-tetramethylpiperidine-4-yl)amino]-6-(2-hydroxyethylamine)-1,3,5-triazine and 2-acryloyloxyethyl isocyanate. The reaction product may be produced by the method described in JP2008-56906A, for example. Those listed above may be used alone or in combination thereof.

Among those listed above, component (E) is preferred to be bis(1,2,2,6,6-pentamethyl-4-piperidyl)sebacate, since weather resistance is maintained for a long duration.

The amount of component (E) in the active energy ray-curable resin composition is preferred to be 0.1-5 parts by mass, more preferably 0.2-3 parts by mass, even more preferably 0.3-2 parts by mass, relative to the total 100 mass % of components (A)-(C). By setting the amount of component (E) to be at least 0.1 parts by mass, the cured film exhibits excellent weather resistance (anti-cracking) and durability. By setting the amount to be no greater than 5 parts by mass, hardness and heat resistance of the cured film are improved.

The composition related to the present invention may further contain photopolymerization initiator (F) (hereinafter may also be referred to as component (F)) so as to obtain a cured film efficiently when ultraviolet rays are irradiated.

### <Component (F)>

Specific examples of component (F) are acetophenones such as diethoxyacetophenone, 2-hydroxy-2-methyl-1-phenylpropane-1-one, benzyl dimethyl ketal, 4-(2-hydroxyethoxy)phenyl-(2-hydroxy-2-propyl)ketone, 1-hydroxycyclohexyl phenyl ketone, 2-methyl-2-morpholino(4-thiomethylphenyl)propan-1-one, 2-methyl-1-[4-(methylthio)phenyl]-2-morpholinopropane-1-one, 2-benzyl-2-dimethyl amino-1-(4-morpholinophenyl)butanone, and 2-hydroxy-2-methyl-1-[4-(1-methylvinyl)phenyl]propanone oligomer; benzoins such as benzoin, benzoin methyl ether, benzoin ethyl ether, benzoin isopropyl ether, and benzoin isobutyl ether; benzophenones such as benzophenone, o-methylbenzyl benzoate, 4-phenyl benzophenone, 4-benzoyl-4′-methyl-diphenyl sulfide, 3,3′,4,4′-tetra(tert-butyl peroxy carbonyl) benzophenone, 2,4,6-trimethyl benzophenone, 4-benzoyl-N,N-dimethyl-N-[2-(1-oxo-2-propenyloxy)ethyl]benzene benzenemethanaminium bromide, and (4-benzoyl-benzyl)trimethyl ammonium chloride; thioxanthones such as 2-isopropylthioxanthone, 4-isopropylthioxanthone, 2,4-diethyl thioxanthone, 2,4-dichloro thioxanthone, 1-chloro-4-propoxy thioxanthone, and 2-(3-dimethylamino-2-hydroxy)-3,4-dimethyl-9H-thioxanthone-9-one methochloride; acylphosphine oxides such as 2,4,6-trimethylbenzoyl-diphenyl phosphine oxide, bis(2,6-dimethoxybenzoyl)-2,4,4-trimethyl-pentyl phosphine oxide, and bis(2,4,6-trimethylbenzoyl)-phenylphosphine oxide; and so forth. They may be used alone or in combination thereof.

Among those listed above, because it provides excellent hardness properties for the composition related to the present invention, and the cured film exhibits high surface hardness, component (F) is preferred to be selected from among acetophenones, benzophenones and acylphosphine oxides, more preferably, benzophenone, 2-hydroxy-2-methyl-1-phenylpropane-1-one, 1-hydroxycyclohexyl phenyl ketone, 2,4,6-trimethylbenzoyl-diphenyl phosphine oxide, bis(2,4,6-trimethylbenzoyl)-phenylphosphine oxide, and 2-methyl-1-[4-(methylthio)phenyl]-2-morpholinopropane-1-one.

The amount of component (F) in the active energy ray-curable resin composition is preferred to be 0.1-10 parts by mass, more preferably 0.5-10 parts by mass, even more preferably 1-5 parts by mass, relative to the total 100 parts by mass of components (A)-(C). When the amount of component (F) is greater, the composition cures better. When the amount of component (F) is less, the cured film is less likely to be yellowed, while hardness and weather resistance of the cured film are improved.

The composition related to the present invention may also contain various additives, if applicable, such as inorganic filler, organic solvent, antioxidant, polymerization inhibitor, anti-yellowing agent, infrared absorber, bluing agent, pigment, leveling agent, antifoaming agent, thickener, anti-settling agent, antistatic agent, and anti-fogging agent.

If applicable, the composition related to the present invention may contain inorganic filler to enhance surface hardness, heat resistance and conductivity properties. From the viewpoints of shape stability, heat resistance, flame retardancy, insulation and the like of the cured film, inorganic filler is preferred to be selected from among metal oxides such as silica, alumina and titanium oxides or their composite oxides; surface-treated metal oxides or surface-treated composite oxides obtained when metal oxides or composite metal oxides are surface-coated with silane coupling agents or the like; and hydroxides such as aluminum, magnesium and potassium hydroxides. To improve conductivity, inorganic filler is preferred to be metal particles of gold, silver, copper or nickel, their alloys and the like; conductive particles of carbons, carbon nanotubes, carbon nanohorns, fullerenes, and the like; and particles formed by coating metals, ITO (indium tin oxide) or the like on the core surfaces of glass, ceramics, plastics, metal oxides and the like. They may be used alone or in combination thereof. Conductive particles are preferred to have an aspect ratio of 5 or greater from the viewpoint of conductivity. Here, aspect ratios are the values determined from (length of a particle)/(breadth of a particle). The particle diameter of inorganic filler is optically preferred to have an area average particle diameter of 1 μm or less. The amount of inorganic filler to be added in an active energy ray-curable resin composition may be adjusted appropriately according to the purposes, mechanical strength properties, fluidity or the like to be required for the composition related to the present invention. Inorganic filler may be added by any known method.

The composition related to the present invention may contain a diluent, if applicable, so the viscosity is adjusted to correspond to a coating method. Examples of a diluent are alcohol-based solvents such as methyl alcohol, ethyl alcohol, isopropyl alcohol, n-butyl alcohol, isobutyl alcohol, sec-butyl alcohol, cyclohexyl alcohol, and diacetone alcohol; ether-based solvents such as methyl cellosolve, cellosolve, butyl cellosolve, methyl carbitol, carbitol, butyl carbitol, diethyl carbitol, and propylene glycol monomethyl ether; aromatic solvents such as “Swasol 1000” (product name, manufactured by Maruzen Petrochemical), “Superzole 100” (product name, Shin Nihon Chemicals Corporation), “Superzole 150” (product name, Shin Nihon Chemicals), benzene, toluene, and xylene; cyclic hydrocarbon-based solvents such as cyclohexane; ketone-based solvents such as acetone, methyl ethyl ketone, methyl isobutyl ketone, diisobutyl ketone, and cyclohexanone; acetate-based solvents such as ethyl acetate, n-butyl acetate, isobutyl acetate, n-amyl acetate, and propylene glycol acetate. They may be used alone or in combination thereof. A diluent is preferred to be selected appropriately according to the type of base material. For example, if polycarbonate is used for the base material, it is preferred to use a diluent, for example, alcohol-based diluents such as isobutanol and ester-based diluents such as n-butyl acetate. Those diluents may be used alone or in combination thereof.

Regarding the amount of a diluent used in the composition related to the present invention, it is preferred to be added so that the amount of curing component in the composition prior to coating is at least 30 mass % of the composition, considering coating efficiency. The amount may also be set to be no greater than 80 mass %. For example, if the composition related to the present invention is spray coated, a diluent is preferred to be added to the composition so that its viscosity is set at 15-30 seconds at 20° C. when a Ford #4 cup is used.

The composition related to the present invention can be used to improve the surfaces of resin molded products for use as a base material for automobile headlamp lenses. When the composition related to the present invention is coated on a base material and irradiated by active energy rays, the composition is crosslinked to form a cured film. The coating amount of the composition relative to the base material is preferred to be set so that the thickness of the cured film will be 1-50 μm, more preferably 3-40 μm. Coating the composition on a base material may be carried out by the following methods, for example, bar coater coating, meyer rod coating, air knife coating, gravure coating, reverse gravure coating, micro gravure coating, brush coating, spray coating, shower flow coating, dip coating, curtain coating, offset printing, flexo printing, screen printing, potting and the like. Also, the composition related to the present invention may be heated to adjust its viscosity prior to coating.

As for active energy rays, ultraviolet rays are preferred, especially ultraviolet rays with a wavelength of 340-380 nm. The light sources of ultraviolet rays are high-pressure mercury lamps, metal halide lamps and the like. The irradiation amount of ultraviolet rays may be set at 1000-5000 mJ/cm² for ultraviolet rays with a wavelength of 340-380 nm. Active energy rays may be irradiated in air or in inert gas such as nitrogen or argon.

After the composition related to the present invention is coated on a base material, heat may be applied prior to irradiation of active energy rays. Heat may be applied by irradiating a near infrared lamp, by circulating hot air or the like. To maintain adhesiveness with the base material under outdoors conditions for a long duration, the surface temperature of base material in the oven during the heating process (hereinafter referred to as heating temperature) is preferred to be 40-90° C. with a heating time of 60-180 seconds, more preferably a heating temperature of 50-70° C. with a heating time of 90-120 seconds. By setting the heating temperature at 40° C. or higher, organic solvents or the like contained in the coating film are sufficiently removed, and hardness, water resistance and weather resistance are thereby improved. By setting the heating temperature at 90° C. or lower, appearance is enhanced and weather resistance is improved. By setting the heating time at 60 seconds or longer, organic solvents or the like contained in the coating film are sufficiently removed, and hardness, water resistance and weather resistance are thereby improved. By setting the heating time at 180 seconds or shorter, appearance is enhanced and weather resistance is improved.

Examples of resin molded products as base materials for automobile headlamp lenses are those containing synthetic resins such as various thermoplastic resins and thermosetting resins, for which improvement on wear resistance and weather resistance has been desired. Specific examples of synthetic resins are: polymethyl methacrylate resins, polycarbonate resins, polyester resins, polystyrene resins, ABS (acrylonitrile-butadiene-styrene) resins, AS resins, polyamide resins, polyarylate resins, polymethacrylimide resins, polyallyl diglycol carbonate resins, and the like. Among them, polymethyl methacrylate, polycarbonate, polystyrene and polymethacrylimide resins are preferred, more preferably polycarbonate resins, since they exhibit excellent transparency, improvement on their wear resistance properties is desired, and application of the composition related to the present invention is especially effective. They may be used alone or in combination thereof. In addition, resin molded products as base materials for forming automobile headlamp lenses may be in a form of sheet or film, or may be various injection-molded products.

Automobile headlamp lenses related to the present invention are formed with a cured film of active energy ray-curable resin composition coated on a resin molded product as the base material. The thickness of the cured film is preferred to be 1-50 μm, more preferably 3-40 μm. Resin molded products are preferred to be made of polycarbonate resin, since the cured film of polycarbonate resin exhibits excellent hardness and weather resistance.

### EXAMPLES

In the following, the present invention is described in further detail by referring to examples and comparative examples. However, the present invention is not limited to those examples and comparative examples unless deviating from the gist of the present invention. In the following, “parts” means “parts by mass.”

### Synthesis Example 1

### Synthesizing Urethane Acrylate Mixture: UA-1 (Component (B))

Into a flask equipped with a dropping funnel, reflux condenser, stirring blade and temperature sensor, as material (b1), 1310 grams (5 mol) of dicyclohexylmethane-4,4-diisocyanate (product name: DESMODUR W, made by Sumika Bayer Urethane Co., Ltd.) was placed along with 0.5 grams of di-n-butyltin dilaurate. Next, heat was applied by a water bath until the internal temperature of the flask reached 70° C. Then, while the internal temperature of the flask was kept at 70° C. and the mixture was stirred, 161 grams (1 mol) of 4-hydroxy-N-(2-hydroxyethyl)-N-methylbutanamide as material (b2), and 1326 grams (1.5 mol) of polytetramethylene glycol with a number-average molecular weight of 877 (in terms of hydroxyl value) (product name: PTG850SN, made by Hodogaya Chemical Co., Ltd.) as material (b3) were dropped out in 3 hours at a constant rate through a dropping funnel with a side tube by keeping the temperature of the materials at 40° C. The mixture was reacted for 2 hours while the temperature was maintained and the mixture was stirred. After that, while the internal temperature of the flask was kept at 80° C., material (b4), which is a homogeneously mixed solution containing 626 grams (5.4 mol) of 2-hydroxyethyl acrylate and 6.0 grams of hydroquinone monomethyl ether, was dropped out in 3 hours at a constant rate through a dropping funnel. Furthermore, the internal temperature of the flask was kept at 80° C. and the mixture was stirred for 4 hours. Accordingly, a urethane acrylate mixture (UA-1) was obtained.

### Synthesis Example 2

### Synthesizing Urethane Acrylate Mixture: UA-2 (Component (B))

Urethane acrylate mixture (UA-2) was obtained the same as in Synthesis Example 1 except that 80 grams (0.5 mol) of 4-hydroxy-N-(2-hydroxyethyl)-N-methylbutanamide was used as material (b2), and 1768 grams (2.0 mol) of polytetramethylene glycol with a number-average molecular weight of 877 (in terms of hydroxyl value) was used as material (b3).

### Synthesis Example 3

### Synthesizing Urethane Acrylate Mixture: UA-3 (Component (B))

Urethane acrylate mixture (UA-3) was obtained the same as in Synthesis Example 1 except that 40 grams (0.25 mol) of 4-hydroxy-N-(2-hydroxyethyl)-N-methylbutanamide was used as material (b2), and 2210 grams (2.25 mol) of polytetramethylene glycol with a number-average molecular weight of 877 (in terms of hydroxyl value) was used as material (b3).

### Synthesis Example 4

### Synthesizing Urethane Acrylate Mixture: UA-4 (Component (B))

Urethane acrylate mixture (UA-4) was obtained the same as in Synthesis Example 1 except that 1461 grams (1.5 mol) of polycarbonate diol with a number-average molecular weight of 1002 (in terms of hydroxyl value) (product name: Kuraray Polyol C-1090, made by Kuraray Co., Ltd.) was used as material (b3).

### Synthesis Example 5

### Synthesizing Urethane Acrylate Mixture: UA-5 (Component (B))

Urethane acrylate mixture (UA-5) was obtained the same as in Synthesis Example 1 except that 1500 grams (1.5 mol) of polycaprolactone diol with a number-average molecular weight of 1002 (in terms of hydroxyl value) (product name: PLACCEL 210, made by Daicel Corporation) was used as material (b3).

### Synthesis Example 6

### Synthesizing Urethane Acrylate: UA-6 (Another Component)

Urethane acrylate (UA-6) was obtained the same as in Synthesis Example 1 except that material (b2) was not used, and 2210 grams (2.5 mol) of polytetramethylene glycol with a number-average molecular weight of 877 (in terms of hydroxyl value) was used as material (b3). Urethane (meth)acrylate, which has at least two (meth)acryloyloxy groups, at least one amide group and at least 2 urethane bonds, is not contained in UA-6.

### Synthesis Example 7

### Synthesizing Urethane Acrylate: UA-7 (Another Component)

Urethane acrylate (UA-7) was obtained the same as in Synthesis Example 1 except that material (b2) was not used and 2435 grams (2.5 mol) of polycarbonate diol with a number-average molecular weight of 1002 (in terms of hydroxyl value) was used as material (b3). Urethane (meth)acrylate, which has at least two (meth)acryloyloxy groups, at least one amide group and at least 2 urethane bonds, is not contained in UA-7.

### Synthesis Example 8

### Synthesizing Urethane Acrylate: UA-8 (Another Component)

Urethane acrylate (UA-8) was obtained the same as in Synthesis Example 1 except that material (b2) was not used and 2500 grams (2.5 mol) of polycaprolactone diol with a number-average molecular weight of 1002 was used as material (b3). Urethane (meth)acrylate, which has at least two (meth)acryloyloxy groups, at least one amide group and at least 2 urethane bonds, is not contained in UA-8.

The amounts (mol) of each of the materials charged into flasks in Synthesis Examples 1-8 are shown in Table 1.

TABLE 1

| | | (number-average) | | | | | | | | |
|---|---|---|---|---|---|---|---|---|---|---|
| | | molecular wt. | UA-1 | UA-2 | UA-3 | UA-4 | UA-5 | UA-6 | UA-7 | UA-8 |
| Material (b1) | H-MDI | 250 | 5 | 5 | 5 | 5 | 5 | 5 | 5 | 5 |
| Material (b2) | 4-hydroxy-N-(2- | 161 | 1 | 0.5 | 0.25 | 1 | 1 | — | — | — |
| | hydroxyethyl)-N- | | | | | | | | | |
| | methylbutanamide | | | | | | | | | |
| Material (b3) | PTG850SN | 877 | 1.5 | 2.0 | 2.25 | — | — | 2.5 | — | — |
| | C1090 | 1002 | — | — | — | 1.5 | — | — | 2.5 | — |
| | PL210 | 1002 | — | — | — | — | 1.5 | — | — | 2.5 |
| Material (b4) | HEA | 116 | 5.4 | 5.4 | 5.4 | 5.4 | 5.4 | 5.4 | 5.4 | 5.4 |

| | | | | | | | | |
|---|---|---|---|---|---|---|---|---|
| Number of (meth)acryloyloxy groups | 2 | 2 | 2 | 2 | 2 | 2 | 2 | 2 |
| Number of amide groups | 1 | 1 | 1 | 1 | 1 | 0 | 0 | 0 |
| Number of urethane bonds | 4 | 4 | 4 | 4 | 4 | 4 | 4 | 4 |

Abbreviations in Table 1 denote the following compounds: H-MDI: dicyclohexylmethane-4,4-diisocyanate (product name: DESMODUR W made by Sumika Bayer Urethane Co., Ltd.);
PTG850SN: polytetramethylene glycol with a number-average molecular weight of 877 (in terms of hydroxyl value) (product name: PTG850SN, made by Hodogaya Chemical Co., Ltd.);
C1090: polycarbonate diol with a number-average molecular weight of 1002 (in terms of hydroxyl value) (product name: Kuraray Polyol C-1090, made by Kuraray Co., Ltd.);
PL210: polycaprolactone diol with a number-average molecular weight of 1002 (in terms of hydroxyl value) (product name: PLACCEL 210, made by Daicel Corporation); and
HEA: 2-hydroxyethyl acrylate.

### Example 1

An active energy ray-curable resin composition was prepared to have a composition ratio shown in Table 2. The composition was spray-coated on a 3 mm-thick polycarbonate resin plate (product name: Panlite L-1225Z, made by Teijin Chemicals Ltd.) to have a film thickness of 8 μm after being cured. The resin plate was thermally treated for 2 minutes in a 60° C.-IR heater furnace so that the diluent in the composition was evaporated. Then, a high pressure mercury lamp was used in ambient air to irradiate energy set to have a wavelength of 340-380 nm, peak luminous intensity of 140 mW/cm², and light accumulation of 3000 mJ/cm² (measured by an ultraviolet intensity meter (product name: UV-351 (model SN), made by ORC Manufacturing Co., Ltd.) at the coated film of the composition to form a cured film. Evaluation results of the obtained laminate are shown in Table 2. Evaluations were conducted as follows.

### (1) Scratch Resistance

A #0000 steel wool was placed on the laminate with a load of 250 g/cm² and used to make 11 round trips for scratch testing. A haze meter (product name: HM-65W, made by Murakami Color Research Laboratory Co., Ltd.) was used to measure haze values before and after the scratch test. Based on the criteria below, scratch resistance was evaluated:

⊚: an increase in haze value is 0% or greater but less than 0.5%;

◯: an increase in haze value is 0.5% or greater but less than 1.5%;

Δ: an increase in haze value is 1.5% or greater but less than 2%; and

×: an increase in haze value is 2.0% or greater.

### (2) Pencil Hardness

Based on JIS K5600, the laminate was scratched using a Uni Mitsubishi Pencil at an angle of 45 degrees. The pencil hardness of the cured film was evaluated as the maximum pencil hardness that did not cause any scratch marks.

### (3) Adhesiveness

Based on JIS K5600, a 100-square grid was made on the surface of a cured film by forming 11 each vertical and horizontal cut lines at an interval of 1 mm. A cellophane tape (Cellotape®, made by Nichiban Co., Ltd.) was adhered to the grid surface and peeled all at once to observe if peeling occurred. Based on the following criteria, adhesiveness was evaluated:

◯: no peeling is observed; and

×: peeling has occurred.

### (4) Hot-Water Resistance

The laminate was immersed in 80° C. hot water for 2 hours and taken out, and adhesiveness testing was conducted by the same process described in (3) above. Based on the following criteria, hot-water resistance was evaluated:

◯: no peeling is observed; and

×: peeling has occurred.

### (5) Weather Resistance

By using a Sunshine Weather Meter (model number WEL-SUN-HC-B, made by Suga Test Instruments Co., Ltd.), weather resistance was tested under the following conditions: black panel temperature of 63±3° C., rainfall for 12 minutes, and irradiation for 48 minutes). After 2000 hours of testing, evaluations were conducted as shown below. An increase in the haze value and an increase in the yellowness index (YI) after 2000 hours of testing each indicate the increased degree between test hours from zero to 2000.

### (a) Appearance

Appearance was evaluated based on the following criteria:

◯: no cracking, cloudiness or peeling of cured film is observed; and

×: at least one of cracking, cloudiness and peeling of cured film has occurred.

(b) Transparency

Using a haze meter (product name: HM-65W, made by Murakami Color Research Laboratory), haze values before and after testing were measured, and the transparency of the laminate was evaluated based on the following criteria:

◯: an increase in haze value is 0% or greater but less than 1.0%;

Δ: an increase in haze value is 1.0% or greater but less than 2.0%; and

×: an increase in haze value is 2.0% or greater.

### (c) Degree of Yellowness

Using an instantaneous multichannel photometric system (product name: MCPD-3000, made by Otsuka Electronics Co., Ltd.), tri stimulus values (X, Y, Z) were measured. Then, yellowness indices (YI) before and after testing were calculated by the formula below, and the degree of yellowness was evaluated based on the following criteria:

yellowness index (Y1)=100×(1.28×X−1.06×Z)/Y

◯: an increase in YI is 0 or greater but less than 1.00;

Δ: an increase in YI is 1.00 or greater but less than 2.00; and

×: an increase in YI is 2.00 or greater.

### (6) Curability

An active energy ray-curable resin composition was prepared to have a composition ratio shown in Table 2. The composition was spray-coated on a 3 mm-thick polycarbonate resin plate (product name: Panlite L-1225Z, made by Teijin Chemicals Ltd.) to have a film thickness of 4 μm after being cured. The resin plate was thermally treated for 2 minutes in a 60° C-IR heater furnace so that the diluent in the composition was evaporated. Then, a high pressure mercury lamp was used in ambient air to irradiate energy set to have a wavelength of 340-380 nm, peak luminous intensity of 50 mW/cm² per irradiation, and light accumulation of 150 mJ/cm² (measured by an ultraviolet intensity meter (product name: UV-351 (model SN), made by ORC Manufacturing Co., Ltd.) at the coated film of the composition to cure the film. The curability of the laminate was evaluated based on the criteria described below.

### (a) Tack-Free Level

Tack-free levels were evaluated when the coated film irradiated under the above conditions was touched by a finger and the number of irradiations was counted until no resin composition adhered to the finger (tack free).

### (b) Appearance

When the coated film became tack free, the appearance was visually observed and evaluated based on the following criteria:

◯: the film is transparent; and

Δ: cloudiness, wrinkles or the like has occurred.

### Examples 2-12, Comparative Examples 1-10

Active energy ray curable-resin compositions were prepared by using their respective composition ratios shown in Tables 2 and 3, and cured films were formed the same as in Example 1. Evaluation results of each laminate are shown in Tables 2 and 3.

TABLE 2

| | | | Examples | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| Active | component | DPHA | 35 | 35 | 35 | 35 | 35 | 25 | 30 | — | 35 | — | 20 | 60 |
| energy | (A) | DPCA-20 | — | — | — | — | — | — | — | 35 | — | 35 | — | — |
| ray-curable | component | UA-1 | 25 | — | — | — | — | 45 | 15 | 25 | 25 | 25 | 10 | 20 |
| resin | (B) | UA-2 | — | 25 | — | — | — | — | — | — | — | — | — | — |
| composition | | UA-3 | — | — | 25 | — | — | — | — | — | — | — | — | — |
| | | UA-4 | — | — | — | 25 | — | — | — | — | — | — | — | — |
| | | UA-5 | — | — | — | — | 25 | — | — | — | — | — | — | — |
| | component | TAIC | 40 | 40 | 40 | 40 | 40 | 30 | 55 | 40 | 40 | 40 | 70 | 20 |
| | (C) | | | | | | | | | | | | | |
| | component | HBPB | 10 | 10 | 10 | 10 | 10 | 10 | 10 | 10 | — | — | 10 | 10 |
| | (D) | HHBT | — | — | — | — | — | — | — | — | 10 | 10 | — | — |
| | component | BPMS | 0.5 | 0.5 | 0.5 | 0.5 | 0.5 | 0.5 | 0.5 | 0.5 | 0.5 | 0.5 | 0.5 | 0.5 |
| | (E) | | | | | | | | | | | | | |
| | component | BNP | 1 | 1 | 1 | 1 | 1 | 1 | 1 | 1 | 1 | 1 | 1 | 1 |
| | (F) | MPG | 1 | 1 | 1 | 1 | 1 | 1 | 1 | 1 | 1 | 1 | 1 | 1 |
| | | BDK | 1 | 1 | 1 | 1 | 1 | 1 | 1 | 1 | 1 | 1 | 1 | 1 |
| | diluent | PGM | 200 | 200 | 200 | 200 | 200 | 200 | 200 | 200 | 200 | 200 | 200 | 200 |
| | | ECA | 10 | 10 | 10 | 10 | 10 | 10 | 10 | 10 | 10 | 10 | 10 | 10 |

| | | | | | | | | | | | | |
|---|---|---|---|---|---|---|---|---|---|---|---|---|
| total | 323.5 | 323.5 | 323.5 | 323.5 | 323.5 | 323.5 | 323.5 | 323.5 | 323.5 | 323.5 | 323.5 | 323.5 |

| (1) Scratch resistance | | ◯ | ◯ | ◯ | ◯ | ◯ | ◯ | ⊚ | ◯ | ◯ | ◯ | ◯ | ⊚ |
|---|---|---|---|---|---|---|---|---|---|---|---|---|---|
| ( ): increase in haze value [%] | | (1.0) | (0.9) | (0.7) | (1.1) | (1.1) | (1.2) | (0.4) | (1.2) | (0.9) | (1.2) | (1.4) | (0.3) |
| (2) Pencil hardness | | F | F | F | F | F | HB | F | F | F | F | F | F |
| (3) Adhesiveness | | ◯ | ◯ | ◯ | ◯ | ◯ | ◯ | ◯ | ◯ | ◯ | ◯ | ◯ | ◯ |
| (4) Hot-water resistance | | ◯ | ◯ | ◯ | ◯ | ◯ | ◯ | ◯ | ◯ | ◯ | ◯ | ◯ | ◯ |
| (5) Weather resistance | (a) appearance | ◯ | ◯ | ◯ | ◯ | ◯ | ◯ | ◯ | ◯ | ◯ | ◯ | ◯ | ◯ |
| | (b) transparency | ◯ | ◯ | ◯ | ◯ | ◯ | ◯ | ◯ | ◯ | ◯ | ◯ | ◯ | ◯ |
| | ( ): increase in | (0.4) | (0.4) | (0.3) | (0.5) | (0.4) | (0.3) | (0.8) | (0.2) | (0.3) | (0.2) | (0.8) | (0.9) |
| | haze value [%] | | | | | | | | | | | | |
| | (c) yellowness | ◯ | ◯ | ◯ | ◯ | ◯ | ◯ | ◯ | ◯ | ◯ | ◯ | ◯ | ◯ |
| | degree | | | | | | | | | | | | |
| | ( ): increase in YI | (0.3) | (0.3) | (0.2) | (0.3) | (0.3) | (0.5) | (0.6) | (0.2) | (0.2) | (0.2) | (0.8) | (0.9) |
| | value | | | | | | | | | | | | |
| (6) Curability | (a) tack-free level | 1 | 2 | 2 | 2 | 2 | 1 | 2 | 1 | 1 | 1 | 2 | 2 |
| | (b) appearance | ◯ | ◯ | ◯ | ◯ | ◯ | ◯ | ◯ | ◯ | ◯ | ◯ | ◯ | ◯ |

TABLE 3

| | | | Comparative Examples | | | | | | | | | |
|---|---|---|---|---|---|---|---|---|---|---|---|---|
| | | | 1 | 2 | 3 | 4 | 5 | 6 | 7 | 8 | 9 | 10 |
| Active | component (A) | DPHA | 50 | 45 | 35 | 35 | 35 | 80 | 5 | 20 | 60 | 5 |
| energy | component (B) | UA-1 | — | 5 | — | — | — | 5 | 40 | 60 | 30 | 5 |
| ray-curable | other | UA-6 | — | — | 25 | — | — | — | — | — | — | — |
| resin | component | UA-7 | — | — | — | 25 | — | — | — | — | — | — |
| composition | | UA-8 | — | — | — | — | 25 | — | — | — | — | — |
| | component (C) | TAIC | 50 | 50 | 40 | 40 | 40 | 15 | 55 | 20 | 10 | 90 |
| | component (D) | HBPB | 10 | 10 | 10 | 10 | 10 | 10 | 10 | 10 | 10 | 10 |
| | component (E) | BPMS | 0.5 | 0.5 | 0.5 | 0.5 | 0.5 | 0.5 | 0.5 | 0.5 | 0.6 | 0.7 |
| | component (F) | BNP | 1 | 1 | 1 | 1 | 1 | 1 | 1 | 1 | 1 | 1 |
| | | MPG | 1 | 1 | 1 | 1 | 1 | 1 | 1 | 1 | 1 | 1 |
| | | BDK | 1 | 1 | 1 | 1 | 1 | 1 | 1 | 1 | 1 | 1 |
| | diluent | PGM | 200 | 200 | 200 | 200 | 200 | 200 | 200 | 200 | 200 | 200 |
| | | ECA | 10 | 10 | 10 | 10 | 10 | 10 | 10 | 10 | 10 | 10 |

| | | | | | | | | | | |
|---|---|---|---|---|---|---|---|---|---|---|
| total | 323.5 | 323.5 | 323.5 | 323.5 | 323.5 | 323.5 | 323.5 | 323.5 | 323.5 | 323.5 |

| (1) Scratch resistance | | ⊚ | ⊚ | ◯ | ◯ | ◯ | ⊚ | X | X | ⊚ | Δ |
|---|---|---|---|---|---|---|---|---|---|---|---|
| ( ): increase in haze value [%] | | (0.2) | (0.2) | (1.3) | (1.3) | (1.2) | (0.1) | (2.4) | (3.1) | (0.4) | (1.8) |
| (2) Pencil hardness | | H | F | B | B | B | H | 2B | 2B | F | HB |
| (3) Adhesiveness | | ◯ | ◯ | ◯ | ◯ | ◯ | ◯ | ◯ | ◯ | ◯ | ◯ |
| (4) Hot-water resistance | | X | ◯ | ◯ | ◯ | ◯ | X | ◯ | ◯ | X | ◯ |
| (5) Weather resistance | (a) appearance | X | X | ◯ | ◯ | ◯ | X | ◯ | ◯ | ◯ | X |
| | (b) transparency | X | X | ◯ | ◯ | ◯ | X | ◯ | ◯ | ◯ | X |
| | ( ): increase in | (2.5) | (2.1) | (0.2) | (0.1) | (0.1) | (3.9) | (0.3) | (0.1) | (0.7) | (2.2) |
| | haze value [%] | | | | | | | | | | |
| | (c) yellowness | X | X | ◯ | ◯ | ◯ | X | ◯ | ◯ | ◯ | Δ |
| | degree | | | | | | | | | | |
| | ( ): increase in | (2.3) | (2.0) | (0.7) | (0.6) | (0.6) | (2.7) | (0.5) | (0.6) | (0.8) | (1.7) |
| | YI value | | | | | | | | | | |
| (6) Curability | (a) tack-free | 3 | 3 | 2 | 2 | 2 | 3 | 1 | 1 | 2 | 3 |
| | level | | | | | | | | | | |
| | (b) appearance | ◯ | ◯ | X | X | X | ◯ | ◯ | ◯ | ◯ | ◯ |

Abbreviations in Table 2 and 3 denote the following compounds:
DPHA: dipentaerythritol hexaacrylate;
DPCA-20: dipentaerythritol hexaacrylate modified with one ε-caprolactone (product name: KAYARAD DPCA-20, made by Nippon Kayaku Co., Ltd.);
TRIC: tris(2-acryloyloxyethyl) isocyanurate;
HBPB: 2-(2-hydroxy-5-tert-butylphenyl)benzotriazole (product name: Tinuvin PS, made by BASF);
HHBT: 2-[4-(2-hydroxy-3-dodecyloxy-propyl)oxy-2-hydroxyphenyl]-4,6-[bis (2,4-dimethylphenyl)-1,3,5-triazine] (product name: Tinuvin 400, made by BASF);
BPMS: bis(1,2,2,6,6-pentamethyl-4-piperidyl) sebacate (product name: Tinuvin 292, made by BASF);
BNP: benzophenone
MPG: methyl phenylglyoxylate;
BDK: 2,2-dimethoxy-1,2-diphenylethane-1-one;
PGM: propylene glycol monomethyl ether; and
ECA: diethylene glycol monoethyl ether acetate.

From the evaluation results above, since active energy ray-curable resin compositions in Examples 1-12 contain all the components (A)-(C), the laminates formed using the compositions have exhibited excellent physical properties. On the other hand, weather resistance was insufficient in Comparative Examples 1 and 2, since component (B) was not added, or a lesser amount was used in active energy ray-curable resin compositions. Moreover, hardness was insufficient in Comparative Examples 3-5, since they were prepared with urethane acrylate that was synthesized without using material (b2).

The present application is based upon and claims the benefit of Japanese Patent Application No. 2014-047417, filed on Mar. 11, 2014. The entire contents of the application are incorporated herein by reference.

So far, the present invention has been described with reference to the embodiments and examples. However, the present invention is not limited to those embodiments and examples. Various modifications understandable to a person skilled in the art may be made to the structure and details of the present invention unless deviating from the scope of the present invention.

### INDUSTRIAL APPLICABILITY

When the active energy ray-curable resin composition related to the present invention is coated on the surface of resin-molded products for forming automobile headlamp lenses and irradiated by active energy rays, automobile headlamp lenses are obtained having a cured film that exhibits excellent scratch resistance and weather resistance. Those lenses are protected by the cured film from ultraviolet rays and scratches, and their excellent appearance is long maintained.

1. An active energy ray-curable resin composition comprising:
poly(meth)acrylate (A) of mono- or poly-pentaerythritol represented by formula (1) below: 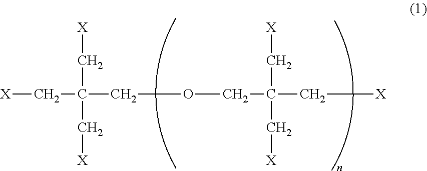
wherein “X's” in formula I are each independently a (meth)acryloyloxy group (CH₂═CR—COO—), a (meth)acryloyl group modified with caprolactone (CH₂═CR—CO(O(CH₂)₅C═O)_{y}—), wherein “R” is hydrogen or a methyl group, and “y” is an integer of 1 or greater, or a (—OH) group; wherein at least three of the “X's” are a (meth)acryloyloxy group (CH₂═CR—COO—) or a (meth)acryloyl group modified with caprolactone (CH₂═CR—CO(O(CH₂)₅C═O)_{y}—), wherein “R” is hydrogen or a methyl group, and “y” is an integer of 1 or greater, and “n” is an integer of 0-4;
a urethane (meth)acrylate mixture (B) containing a urethane (meth)acrylate having at least two (meth)acryloyloxy groups, at least one amide group, which does not include the —NH—CO— structure in the urethane bond, and at least two urethane bonds; and
poly[(meth)acryloyloxy alkyl]isocyanurate (C) represented by formula (2) below: 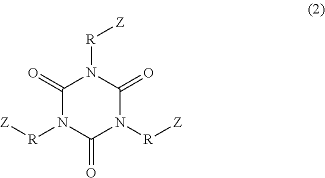
wherein “Z's” in formula (2) are each independently a (meth)acryloyl group, hydrogen atom, or alkyl group, and at least two “Z's” are (meth)acryloyl groups and wherein “R's” are each independently a C1-C4 oxyalkylene group;
wherein (A) is set at 10-70 mass %, (B) at 10-50 mass % and (C) at 20-80 mass % relative to the total 100 mass % of (A), (B) and (C).

2. The active energy ray-curable resin composition according to claim 1, wherein the urethane (meth)acrylate mixture (B) is obtained by reacting materials (b1)-(b4) below:
(b1): diisocyanate;
(b2): a compound containing at least one amide group, which does not include the —NH—CO— structure in the urethane bond, and at least two hydroxyl groups;
(b3): at least one type of diol selected from the group consisting of polyether diols, polycarbonate diols, and polyester diols other than material (b2); and
(b4): a (meth)acrylic acid ester having at least one (meth)acryloyloxy group, and one hydroxyl group.

3. The active energy ray-curable resin composition according to claim 2, wherein material (b3) is a polyether diol other than material (b2).

4. The active energy ray-curable resin composition according to claim 2, wherein the molar equivalent ratio of materials (b1)-(b4) is [material (b1)]/[material (b2)+material (b3)]/[material (b4)]=10/4-6/4-6.

5. The active energy ray-curable resin composition according to claim 2, wherein the molar equivalent ratio of materials (b2) and (b3) is material (b2)/material (b3)=1-5/5-1.

6. The active energy ray-curable resin composition according to claim 2, wherein the molar equivalent ratio of materials (b1)-(b4) is [material (b1)]/[material (b2)+material (b3)]/[material (b4)]=10/4-6/4-6, and the molar equivalent ratio of materials (b2) and (b3) is material (b2)/material (b3)=1-5/5-1.

7. The active energy ray-curable resin composition according to claim 1, further comprising at least either an ultraviolet absorber (D) or a hindered-amine light stabilizer (E).

8. The active energy ray-curable resin composition according to claim 1, wherein the resin molded product for forming automobile headlamp lenses is a polycarbonate resin molded product.

9. An automobile headlamp lens, comprising:
a cured film of the active energy ray-curable resin composition according to claim 1,
wherein the cured film is formed on a resin molded product.

10. The automobile headlamp lens according to claim 9, wherein the resin molded product is a polycarbonate resin molded product.

11. The active energy ray-curable resin composition of claim 1 in a form suitable for forming a curable or cured film on the surface of a resin molded product to be used for an automobile headlamp lens.

12. A method for producing a resin molded product comprising applying the active energy ray-curable composition of claim 1 to a resin molded product, optionally in a thickness ranging from 1 to 50 μm; optionally thermally treating the resin molded product to which the composition has been applied; and curing the applied composition with an active energy ray, optionally having a wavelength of 340-380 nm.

13. The method of claim 12, wherein the resin-molded product is an automobile headlamp lens.
